(19) United States
(12) Patent Application Publication
(10) Pub. No.: US 2006/0229882 A1
(43) Pub. Date: Oct. 12, 2006

(54) Method and system for modifying printed text to indicate the author's state of mind

(75) Inventors: Denis J. Stemmle, Stratord, CT (US); Judith D. Auslander, Westport, CT (US); Kevin W. Bodie, Brookfield, CT (US); John F. Braun, Fairfield, CT (US); Thomas J. Foth, Trumbull, CT (US); William Kilmartin, West Haven, CT (US); Frederick W. Ryan JR., Oxford, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/092,645

(22) Filed: Mar. 29, 2005

(51) Int. Cl. G10L 11/00

(52) U.S. Cl. 704/277

(57) ABSTRACT

A method and system for producing a printed text. A system operates in accordance with the method to: receive a message signal created by an author and representative of the semantic content of a printed text; produce a text signal in response to the message signal; analyze the message signal to determine a non-semantic indicator of the author's state of mind; determine a non-semantic characteristic of the printed text as a function of the determined non-semantic indicator; and printing the printed text in response to the text signal and the determined characteristic. The message signal can be a voice signal. A physiological signal such as pulse rate or variations in the pace, volume, tremulation, or average wavelength of the author's speech can also be used to determine the author's state of mind. In another embodiment of the invention, a system operates to input a message signal; generate a text signal representative of the printed text; analyze the message signal to determine a non-semantic indicator of the author's state of mind; map a state of mind indicator vector comprising the determined non-semantic indicator into an actual state of mind vector; and determine a non-semantic characteristic of the printed text as a function of the actual state of mind vector; and to print the text in accordance with the text signal and the determined non-semantic characteristic.

### BACKGROUND OF THE INVENTION

The subject invention relates to a method for producing a printed text where non-semantic characteristics of the text are modified to indicate the author's state of mind, and to a system for carrying out that method. More particularly, it relates to a method and system for generating a printed text from a voice input where non-semantic characteristics of the text are modified to indicate the author's state of mind.

A well-known disadvantage of written, and particularly printed communications, in comparison to spoken, face-to-face communication, or even telephonic communication, is that indications of the author's state of mind (e.g., mood, interest in, or concern about the subject) are not provided in a way comparable to indications provided by the emphasis, tempo, loudness, tone, or the like of a speaker's voice. As a result, it is common for recipients of printed messages to misinterpret the message: taking offense where none was intended, under reacting to important messages, or overreacting to routine messages. Conversely, authors will sometimes compose a message in the heat of the moment without recognizing their own state of mind or the likely impact of their message. This is a particular problem with e-mail messages where hitting the “send button” is both easy and irrevocable. (As used herein the term “state of mind” is intended to include the emotional state of the author; e.g., peacefulness, anger, frustration, excitement, delight, disappointment, etc. It is not intended to include the author's intent behind, or underlying reason for, the message; e.g., persuasion or disinterested reporting.)

Some authors attempt to overcome this problem by incorporating typographic features such as underlining, or symbols commonly known as “emoticons” (e.g., “:-)”) into a text. While this approach may add to the expressiveness of a printed message, it has the disadvantage that it does not reflect the author's actual state of mind; but rather expresses what the author chooses to describe as his or her state of mind. Such typographic features are semantic; expressing what the author chooses to say rather than his or her state of mind as it is said.

Thus, it is an object of the subject invention to provide a method and system for generating a printed text where non-semantic characteristics provide an indication of the author's state of mind.

### SUMMARY OF THE INVENTION

The above object is achieved and the disadvantages of the prior art are overcome in accordance with the subject invention by a method and system operating in accordance with the method for: a) receiving a message signal created by an author and representative of the semantic content of the printed text; b) producing a text signal in response to the message signal; c) analyzing the message signal to determine a non-semantic indicator of the author's state of mind; d) determining a non-semantic characteristic of the printed text as a function of the determined non-semantic indicator; and e) printing the printed text in response to the text signal and the determined characteristic.

In accordance with one aspect of the subject invention, the message signal is a voice signal.

In accordance with another aspect of the subject invention, the non-semantic characteristic is a typographic characteristic.

In accordance with another aspect of the subject invention, the non-semantic characteristic directly represents the determined non-semantic indicator.

In accordance with another aspect of the subject invention, the non-semantic characteristic is determined as a function of the non-semantic indicator and at least one additional non-semantic indicator of the author's state of mind.

In accordance with still another aspect of the subject invention the method includes further steps for: a) receiving a physiological signal; b) analyzing the physiological signal to determine a physiological non-semantic indicator of the author's state of mind; c) determining a non-semantic, physiological indicator characteristic of the printed text as a function of the determined physiological indicator; and d) printing the message in further response to the physiological indicator characteristic.

In accordance with another aspect of the subject invention, the physiological indicator characteristic directly represents the determined physiological indicator.

In accordance with another aspect of the subject invention, the non-semantic characteristic is determined as a function of the non-semantic indicator and the determined physiological indicator.

In accordance with another aspect of the subject invention, determining steps include the substeps of: a) mapping a state of mind indicator vector comprising the determined non-semantic indicator into an actual state of mind vector; and b) determining a non-semantic characteristic of the printed text as a function of the actual state of mind vector.

In accordance with another aspect of the subject invention, the state of mind indicator vector further includes the physiological non-semantic indicator and the method includes the further steps of: a) receiving a physiological signal; b) analyzing the physiological signal to determine a physiological non-semantic indicator of the author's state of mind.

Other objects and advantages of the subject invention will be apparent to those skilled in the art from consideration of the detailed description set forth below and the attached drawings.

### BRIEF DESCRIPTION OF THE DRAWINGS

The present invention is illustrated by way of example, and not by way of limitation, in the figures of the accompanying drawings in which like reference numerals refer to similar elements or steps and in which:

FIG. 1 shows a system in accordance with an embodiment of the subject invention for generating a printed text incorporating representations of various indications of the author's state of mind.

FIG. 2 shows a system in accordance with another embodiment of the subject invention for generating a printed text incorporating representations of the author's state of mind.

FIG. 3 shows a flow diagram of the operation of the system of FIG. 1.

FIG. 4 shows a flow diagram of the operation of the system of FIG. 2.

### DETAILED DESCRIPTION OF PREFERRED EMBODIMENTS OF THE INVENTION

FIG. 1 shows system 1 where author 10 dictates into microphone 12 which is connected to conventional voice recognition system 14 and state of mind indicator system 16 to input a signal representative of the semantic content of a message (hereinafter sometimes “message signal”) to each of systems 12 and 14. Voice recognition system 14 operates on the message signal to generate a second signal representative of a printed text having the same semantic content as the message signal (hereinafter sometimes “text signal”) and outputs it to word processing system 20 where the text signal is combined with non-semantic typographic characteristics, such as font and point size, to generate a printed text representative of the message. Such combinations of voice recognition and word processing systems are well-known and need not be described further here for an understanding of the subject invention.

System 1 also includes sensor 22 which is connected to state of mind indicator system 16 to input a signal representative of a physiological indication of author 10's state of mind (hereinafter sometimes “physiological signal”). (While only a single sensor 22 is shown, it will be apparent to those skilled in the art that multiple sensors monitoring multiple physiological indicators can be incorporated into system 1, or system 2, described below.) System 16 analyzes the message signal and the physiological signal to determine one or more non-semantic indicators of author 10's state of mind (e.g., heart rate, loudness of speech) and modifies the non-semantic characteristics of the printed message, preferably typographic characteristics such as point size or font, correspondingly, as will be described further below. Preferably system 16 communicates with system 14 so that changes in the typographic characteristics can be synchronized with the words of the printed text as it is believed that this will produce a more readable document.

In FIG. 2, system 2 is substantially similar to system 1 except that state of mind recognition artificial intelligence system 24 is substituted for state of mind indicator system 16. System 24 analyzes the message signal and physiological signal to determine one or more non-semantic indicators of author 10's state of mind, maps the indicators into actual states of mind of speaker 10 (e.g., emphatic, concerned) and modifies the typographic characteristics of the printed message correspondingly, as will be described further below. Messages produced by system 2 will be modified to represent a state of mind inferred by artificial intelligence (hereinafter sometimes “AI”) system 24 from non-semantic indicators, while system 16 produces messages which are modified to represent the indicators directly; relying on the message recipient to infer author 10's state of mind from the non-semantic indicators substantially as though they were speaking to each other.

It is recognized that inferring a state of mind is difficult, and that even people who know each other well often will fail to correctly interpret each other's state of mind when speaking together. However, it should be noted that people generally are able to at least broadly classify the state of mind of a speaker not known to them with a substantial degree of accuracy. Accordingly, it is believed that conventional methods can be used to train Al systems such as neural networks to map non-semantic indicators into states of mind with at least a useful degree of accuracy; perhaps approximating that with which an ordinary listener can infer the state of mind of an unknown speaker. For example, U.S. Pat. No. 6,236,968; to: Kanewsky et al.; issued May 22, 2001, relates to a system which recognizes the degree of alertness of a driver based, at least in part, on non-semantic indicators in spoken responses to statements or questions generated by the system.

It should also be noted that recent research has shown that facial expressions are reliable expressions of a person's state of mind, even across substantial cultural differences. Accordingly, it should be noted that other embodiments of systems 1 and 2 which include cameras for input of facial expressions or other types of sensors 22 for input of other physiological signals are within the contemplation of the subject invention.

FIG. 3 shows a flow diagram of the operation of state of mind indicator system 16 in accordance with an embodiment of the subject invention where text color is varied to directly represent author 10's heart rate HR, and point size is varied to directly represent loudness of author 10's speech. (It will be understood that voice recognition system 14 and word processing system 20 operate concurrently in a conventional manner which need not be described further here for an understanding of the subject invention.) At step 30, system 16 is initialized. A pulse count value is set equal to 0, and text color and point size are set to default values. Preferably during initialization step 30, the voice signal and pulse count physiological signal for the complete message are buffered and analyzed to determine norms. Loudness and pulse count are thereafter measured relative to the norms. This is preferred since absolute loudness, pulse count or other signals, can vary in response to conditions unrelated to author 10's state of mind; e.g., microphone position. In other embodiments of the subject invention, norms can be established over multiple messages or, for long messages, over portions of a message. In still other embodiments of the subject invention, absolute measures can be used.

After system 1 begins operation, at step 31 a value T is set equal to current time t, and at step 32 system 16 replays the voice message signal and the pulse count of the physiological signal. Then at step 34, system 16 determines if t−T>P, (where P is a predetermined period for determining heart rate HR), and if so, goes to step 36 and otherwise goes to step 40. At step 36, system 16 calculates author 10's heart rate as HR=Pulse Count /P, maps HR into the text color in a predetermined manner, resets the pulse count to 0 and T=t, and then goes to step 40.

At step 40, system 16 communicates with system 14 to determine if a word (or punctuation mark, etc.) has been recognized and sent to word processor 20, and, if not returns to step 32. Otherwise, at step 42, system 16 analyzes the stored voice signal and computes relative loudness and sets the text point size to correspond. Then at step 44, system 16 outputs text color and point size to word processor 20 so that the word sent from system 14 is printed with a point size corresponding to the loudness with which author 10 spoke and with a color corresponding to his or her heart rate, thus allowing a reader to make reasonable inferences about author 10's state of mind or alerting author 10 to the possible need to reconsider the message before it is sent. Then at step 46, system 16 determines if the message is completed and, if not, returns to step 32 and, if the message is completed, the session ends.

While system 16 has been described with only two states of mind indicators for ease of understanding, it should be noted, as discussed above, that development of systems which detect multiple physiological indicators (e.g., respiration rate, blood pressure, etc.) and multiple text signal indicators (e.g., changes in voice pitch, tempo, etc.) and maps these indictors into multiple text characteristics (e.g., font, bolding, underlining, etc.) are well within the ability of one skilled in the art. It should also be noted that indicators and corresponding non-semantic characteristic variations can be functions of two or more measurements. For example, point size can vary with both loudness and pitch of the voice signal.

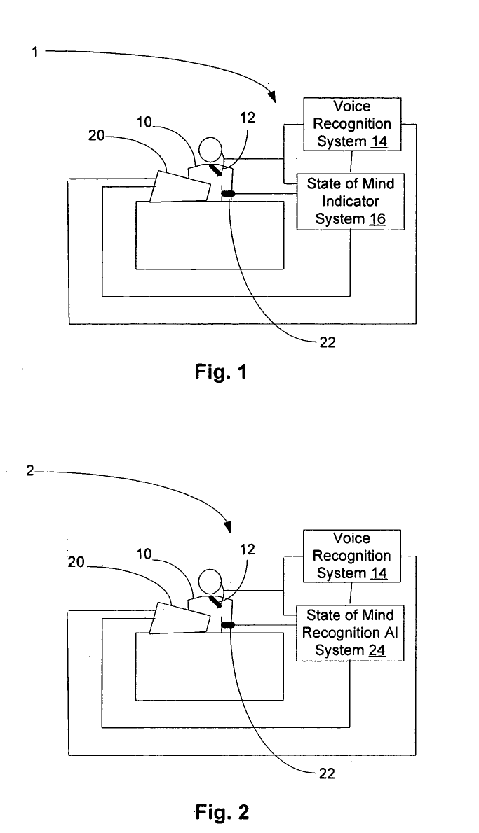

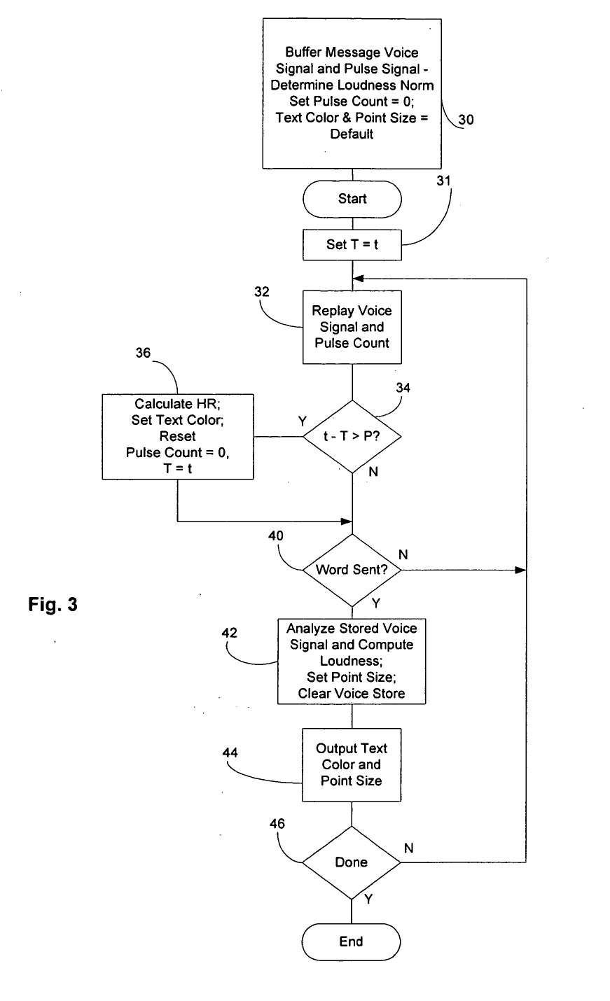

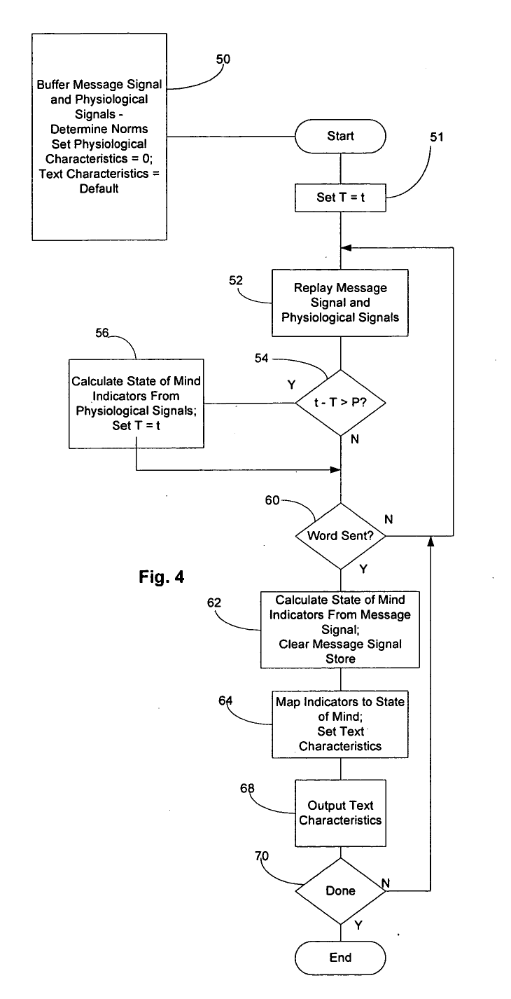

FIG. 4 shows a flow diagram of the operation of state of mind recognition AI system 24 in accordance with an embodiment of the subject invention where typographic characteristics are varied to represent the state of mind of author 10 as inferred by system 24, rather than directly representing the non-semantic indicators as described above in regard to FIGS. 1 and 3. (Again, it will be understood that voice recognition system 14 and word processing system 20 operate concurrently in a conventional manner.) At step 50, system 24 is initialized. Physiological values are set equal to 0 and typographic characteristics are set to default values. Preferably, as described above in regard to FIG. 3, during initialization step 50, the message signal and physiological signals for the complete message are buffered and analyzed to determine norms. State of mind indicators are calculated thereafter relative to the norms.

After system 2 begins operation, at step 51 a value T is set equal to current time t, and at step 52, system 24 replays the message signal and the physiological signal(s). Then at step 54, system 24 determines if t−T>P, (where P is a predetermined period for determining physiological responses) and, if so, goes to step 56 and otherwise goes to step 60. At step 66, system 24 calculates one or more states of mind indicators from physiological indicators, resets T=t, and then goes to step 60.

At step 60, system 24 communicates with system 14 to determine if a word (or punctuation mark, etc.) has been recognized and sent to word processor 20, and, if not returns to step 52. Otherwise at step 62 system 24 analyses the stored message signal and computes state of mind indicators. Then at step 64 system, 24 maps the indicators to author 10's state of mind and sets the typographic characteristics correspondingly. (Preferably system 24 will comprise a neural network, or other AI component, which has been trained in a conventional manner to map a state of mind indicator vector into an actual state of mind vector.) Then at step 68, system 24 outputs the typographic characteristics to word processing system 20. Then at step 70, system 24 determines if the message is completed and, if not, returns to step 52 and otherwise ends the session.

In other embodiments the typographic, or other non-semantic characteristics of the text, which represent indicators of, or actual, states of mind are not immediately displayed in the text but are hidden to be called up by a message recipient. Such hidden characteristics can be alphanumeric or graphic representations of indicators or states of mind for selected portions of the text.

In other embodiments of the subject invention, other message and physiological non-semantic indicators of states of mind can be used. Besides loudness, pacing, clipped speech patterns, etc., it is also relatively simple to detect extra tremors compared to normal voice prints for a speaker which likely indicate tension, and might be represented in a different font type. Similarly, other physiological indicators such as skin moistness can be used.

It is believed that useful state of mind indicators can be derived from message signals from keyboards (in terms of keystroke pressure, tempo, rate etc.) and from handwriting tablets or the like; and systems operating on such message signals are within the contemplation of the subject invention.

The embodiments described above and illustrated in the attached drawings have been given by way of example and illustration only. From the teachings of the present application, those skilled in the art will readily recognize numerous other embodiments in accordance with the subject invention. Accordingly, limitations on the subject invention are to be found only in the claims set forth below.

What is claimed is:

1. A method for producing a printed text, said method comprising the steps of:
a) receiving a message signal created by an author and representative of the semantic content of said printed text;
b) producing a text signal in response to said message signal;
c) analyzing said message signal to determine a non-semantic indicator of said author's state of mind;
d) determining a non-semantic characteristic of said printed text as a function of said determined non-semantic indicator; and
e) printing said printed text in response to said text signal and said determined characteristic.

2. A method as described in claim 1 where said message signal is a voice signal.

3. A method as described in claim 1 where said non-semantic characteristic is a typographic characteristic.

4. A method as described in claim 1 where said non-semantic characteristic directly represents said determined non-semantic indicator.

5. A method as described in claim 1 where said non-semantic characteristic is determined as a function of said non-semantic indicator and at least one additional non-semantic indicator of said author's state of mind.

6. A method as described in claim 1 comprising the further steps of:
a) receiving a physiological signal;
b) analyzing said physiological signal to determine a physiological non-semantic indicator of said author's state of mind;
c) determining a non-semantic, physiological indicator characteristic of said printed text as a function of said determined physiological indicator; and
d) printing said message in further response to said physiological indicator characteristic.

7. A method as described in claim 6 where said physiological indicator characteristic directly represents said determined physiological indicator.

8. A method as described in claim 1 where said non-semantic characteristic is determined as a function of said non-semantic indicator and said determined physiological indicator.

9. A method as described in claim 1 where said determining step includes the substeps of:
a) mapping a state of mind indicator vector comprising said determined non-semantic indicator into an actual state of mind vector; and
b) determining a non-semantic characteristic of said printed text as a function of said actual state of mind vector.

10. A method as described in claim 9 where said message signal is a voice signal.

11. A method as described in claim 9 where said non-semantic characteristic is a typographic characteristic.

12. A method as described in claim 9 comprising the further steps of:
a) receiving a physiological signal;
b) analyzing said physiological signal to determine a physiological non-semantic indicator of said author's state of mind; and
c) where said state of mind indicator vector further comprises said physiological non-semantic indicator.

13. A method as described in claim 1 where said analyzing step includes the substeps of:
a) establishing a norm for said non-semantic indicator for said author; and
b) determining variations of said non-semantic indicator from said norm.

14. A system for producing a printed text, comprising:
a) means for input of a message signal created by an author and representative of the semantic content of a said printed text;
b) a recognition system responsive to said message signal to generate a text signal representative of said printed text;
c) a state of mind indicator system responsive to said message signal to:
c1) analyze said message signal to determine a non-semantic indicator of said author's state of mind;
c2) determine a non-semantic characteristic of said printed text as a function of said determined non-semantic indicator; and
d) a word processing system responsive to said text signal and said determined non-semantic characteristic to print said text.

15. A system as described in claim 14 where said message signal is a voice signal, and said recognition system is a voice recognition system.

16. A system as described in claim 14 further comprising:
a) a sensor for input of a physiological signal representative of a physiological indication of said author's state of mind; and
b) where said state of mind indicator system is responsive to said physiological signal to:
b1) analyze said physiological signal to determine a physiological non-semantic indicator of said author's state of mind;
b2) determine a non-semantic physiological indicator characteristic of said printed text as a function of said determined physiological indicator; and
c) where said word processing system is further responsive to said physiological indicator characteristic to print said text.

17. A system as described in claim 14 where said state of mind indicator system carries out said analysis of said message signal by:
a) establishing a norm for said non-semantic indicator for said author; and
b) determining variations of said non-semantic indicator from said norm .

18. A system for producing a printed text, the system comprising:
a) means for input of a message signal created by an author and representative of said semantic content of a said printed text;
b) a recognition system responsive to said message signal to generate a text signal representative of said printed text;
c) a state of mind recognition artificial intelligence system responsive to said message signal said artificial intelligence system being trained to:
c1) analyze said message signal to determine a non-semantic indicator of said author's state of mind;
c2) map a state of mind indicator vector comprising said determined non-semantic indicator into an actual state of mind vector; and
c3) determine a non-semantic characteristic of said printed text as a function of said actual state of mind vector; and
d) a word processing system responsive to said text signal and said determined non-semantic characteristic to print said text.

19. A system as described in claim 18 further comprising:
a) a sensor for input of a physiological signal representative of a physiological indication of said author's state of mind; and
b) where said artificial intelligence system is responsive to said physiological signal to analyze said physiological signal to determine a physiological non-semantic indicator of said author's state of mind; and
c) where said state of mind indicator vector further comprises said physiological non-semantic indicator.

20. A system as described in claim 18 where said message signal is a voice signal, and said recognition system is a voice recognition system.

21. A system as described in claim 18 where said state of mind indicator system carries out said analysis of said message signal by:
a) establishing a norm for said non-semantic indicator for said author; and
b) determining variations of said non-semantic indicator from said norm.
